(19) United States
(12) Patent Application Publication
(10) Pub. No.: US 2010/0183824 A1
(43) Pub. Date: Jul. 22, 2010

(54) METHOD OF FABRICATING FLEXIBLE FILM

(75) Inventors: Min Keun Seo, Yongin-si (KR); Woon Soo Kim, Yongin-si (KR); Myung Ho Park, Suwon-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/376,894

(22) PCT Filed: Dec. 12, 2007
(86) PCT No.: PCT/KR07/06475

§ 371 Date: Apr. 17, 2009

(51) Int. Cl. B05D 3/12

(52) U.S. Cl. 427/560

(57) ABSTRACT

A method of fabricating a flexible film is provided. The method includes opening an imide ring on a polyimide film; applying a catalyst to the polyimide film; removing tin from the catalyst; forming a first metal film on the polyimide film; drying the polyimide film having the first metal film at a temperature of 110-200° C.; and forming a second metal film on the first metal film. According to the method, it is possible to fabricate a flexible film without a requirement of an adhesive layer and thus provide a flexible film with excellent physical properties such as excellent plating properties, high adhesive strength, high heat resistance, high drug resistance, excellent migration properties and high folding endurance.

### TECHNICAL FIELD

The present invention relates to a flexible film and a method of fabricating the flexible film, and more particularly, to a method of fabricating a flexible film which involves an etching operation, a catalyst bonding operation and a drying operation.

### BACKGROUND ART

Flexible films, which are a core element of flexible printed circuit boards (FPCBs) that are widely used in the manufacture of display devices, include an insulation film layer and a conductive metal layer. Examples of flexible films include flexible copper clad laminate (FCCL) films.

Polyester films, polyimide films, liquid crystal polymer films, or fluorine resin films may be used as insulation films of flexible films. Polyimide films have been most widely used in the manufacture of flexible films because of their excellent physical properties (such as high heat resistance, high dimensional stability, and excellent solderability properties). Conductive metal films of flexible films may include a highly conductive metal such as gold or copper. Copper has been more widely used than gold as the material of conductive metal films of flexible films because of its high cost effectiveness.

Flexible films may be fabricated using a lamination method, a casting method, or a plating method. The lamination method involves applying a polyimide adhesive onto a polyimide film, baking the polyimide film in an oven so as to fix the polyimide adhesive onto the polyimide film, placing a copper film on the polyimide film, and performing press processing. The casting method has recently been widely used in the manufacture of flexible films, and involves applying a liquid-phase polyimide film precursor onto a copper film and drying the copper film in an oven at high temperature so as to plasticize the liquid-phase polyimide film precursor.

The plating method involves forming a seed layer on a polyimide film to a thickness of several submicrons using a metal and using a sputtering method or a lamination method, forming a metal film on the polyimide film using an electroplating method. Flexible films obtained by the plating method are referred to as conductive metal plated polyimide substrates.

The plating method, unlike the lamination method or the casting method, does not involve the use of a copper film as a conductive layer and can thus freely adjust the thickness of a copper film through electroplating after sputtering. However, the plating method involves forming a metal layer in a vacuum atmosphere and thus increases the cost of equipment and the manufacturing cost of flexible films. In addition, flexible films obtained by the plating method additionally require an etching operation for removing seed layers, including nickel (Ni), chromium (Cr), or cobalt (Co), in order to be processed into flexible printed circuit boards (FPCBs) or chip-on-films (COFs). Moreover, flexible films obtained by the plating method may suffer from a relatively poor adhesion between a metal film and a polyimide film.

Furthermore, polyimide films that can be readily used in the plating method are relatively rare, and flexible films obtained by the plating method generally have poorer physical properties (e.g., weak peel strength) than flexible films obtained by the lamination method or the casting method.

### DISCLOSURE

### Technical Problem

The present invention provides a method of fabricating a flexible film which includes a catalyst bonding operation and a drying operation and can thus provide flexible films with excellent physical properties (e.g., excellent plating properties, high adhesive strength, high heat resistance and high folding endurance).

### TECHNICAL SOLUTION

According to an aspect of the present invention, there is provided a method of fabricating a flexible film, the method including opening an imide ring on a polyimide film; applying a catalyst to the polyimide film; removing tin from the catalyst; forming a first metal film on the polyimide film; drying the polyimide film having the first metal film at a temperature of 110-200° C.; and forming a second metal film on the first metal film.

### ADVANTAGEOUS EFFECTS

It is possible to fabricate a flexible film without a requirement of an adhesive layer and thus provide a flexible film with excellent physical properties such as excellent plating properties, high adhesive strength, high heat resistance, high drug resistance, excellent migration properties and high folding endurance.

### DESCRIPTION OF DRAWINGS

The above and other features and advantages of the present invention will become more apparent by describing in detail preferred embodiments thereof with reference to the attached drawings in which:

FIG. 1 illustrates a flowchart of a method of fabricating a flexible film according to an embodiment of the present invention;

FIG. 2 illustrates a graph of average adhesive strength measurement results obtained from flexible films obtained by the method illustrated in FIG. 1, and FIG. 3 illustrates a graph of folding endurance measurement results obtained from flexible films obtained by the method illustrated in FIG. 1;

FIG. 4 illustrates a cross-sectional view of a flexible film according to an embodiment of the present invention, FIG. 5 illustrates a cross-sectional view of a flexible film according to another embodiment of the present invention, and FIG. 6 illustrates a cross-sectional view of a flexible film according to another embodiment of the present invention; and

FIGS. 7 and 8 illustrate a display device having flexible films, according to an embodiment of the present invention.

### BEST MODE

The present invention will hereinafter be described in detail with reference to the accompanying drawings in which exemplary embodiments of the invention are shown.

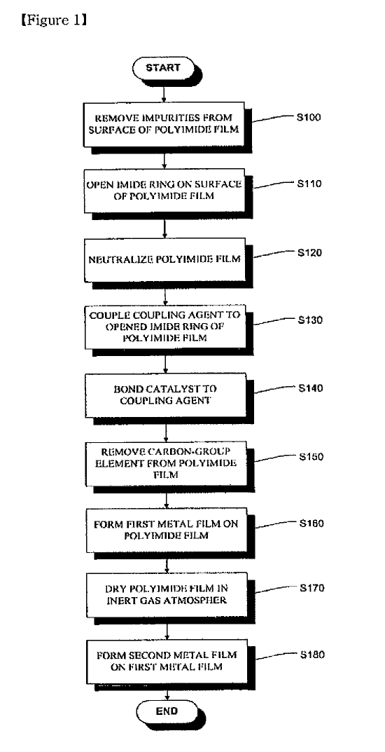

FIG. 1 illustrates a flowchart of a method of fabricating a flexible film according to an embodiment of the present invention. Referring to FIG. 1, a dust removal operation is performed so that impurities such as dust and dirt can be removed from the surface of a polyimide film (S100). More specifically, impurities (e.g., dirt, grease, and fingerprints) on the surface of the polyimide film which result from the manufacture of the polyimide film may adversely affect the peel strength of the polyimide film and thus need to be removed by performing the dust removal operation. The dust removal operation may be performed on the polyimide film using an alkali-based rinse or shampoo as a dust removal solution.

The dust removal operation may be performed on the polyimide film at a temperature of 20-40° C. for one to five minutes. If the dust removal operation is performed on the polyimide film at a temperature lower than 20° C., the dust removal solution may not be properly activated, thereby making it less likely to fully obtain the benefits of the dust removal operation. On the other hand, if the dust removal operation is performed at a temperature higher than 40° C., it may be difficult to properly control the time required to perform the dust removal operation.

In the dust removal operation, ultrasound waves may be applied to the polyimide film, thereby inducing successive reactions. Since polyimide is a highly flexible material, polyimide can cause successive reactions when ultrasound waves are applied thereto.

After the dust removal operation, an etching operation is performed so that an imide ring on the surface of the polyimide film can be opened (S110). More specifically, the polyimide film is immersed in an etching solution having a temperature of 45-60° C. for about five to seven minutes so that the surface of the polyimide film can be modified. Potassium hydroxide (KOH), a mixed solution of ethylene glycol and KOH, sodium hydroxide (NaOH), a mixed aqueous solution of pyrrolidone and NaOH, or a mixed solution of chromic anhydride and sulfuric acid may be used as the etching solution.

Due to the etching operation, it is possible to maximize the adhesion between the polyimide film and a metal film in a plating operation and thus to enhance the peel strength of the polyimide film 110. As a result of the etching operation, an imide ring of the polyimide film 110 is opened and then transformed into an amide radical or a carboxyl radical.

If the etching operation is performed at a temperature lower than 45° t., the etching solution may not be properly activated, thereby making it less likely to fully obtain the benefits of the etching operation. On the other hand, if the etching operation is performed at a temperature higher than 60° C., the etching operation may proceed too rapidly, thereby making it difficult to control the uniformity and continuity of the surface of the polyimide film and even causing damage to the polyimide film.

In the etching operation, like in the dust removal operation, ultrasound waves may be applied to the polyimide film, thereby inducing successive reactions.

After the etching operation, a neutralization operation can be optionally performed by immersing the polyimide film 110 in chorine acid (HCl) at room temperature for about five to seven minutes (S120). The neutralization operation involves removing metal positive ions remained on the surface of the polyimide film through, for example, a substitution reaction. Due to the neutralization operation, it is possible to expedite a subsequent coupling operation.

If the neutralization operation is performed at a temperature lower than 10° C., a neutralization solution used in the neutralization operation may not be properly activated, thereby making it less likely to fully obtain the benefits of the neutralization operation. On the other hand, if the neutralization operation is performed at a temperature higher than 30° C., it may be difficult to control the neutralization operation. Therefore, the neutralization operation may be performed at a temperature of 10-30° C.

In the neutralization operation, like in the dust removal operation or the etching operation, ultrasound waves may be applied to the polyimide film, thereby inducing successive reactions.

After the neutralization operation, a coupling operation is performed by immersing the polyimide film in a solution of a predetermined coupling agent at a temperature of about 30-45° C. for several minutes (S130). The coupling operation involves coupling the coupling agent onto the surface of the polyimide film with an imide ring opened. As a result of the coupling operation, the surface of the polyimide film is polarized. Thus, it is possible to smoothly perform a plating operation on the polyimide film and to enhance the plating uniformity, the continuity, and the peel strength of a flexible film.

A silane radical or an amine radical may be used as the coupling agent. Any type of coupling solution may be used as long as it can provide a coupling agent. More specifically, a silane coupling agent containing an aminopropyltriethoxysilane, an alkali-based coupling agent containing sodium oxide and monomethylamine, or an acid-based coupling agent containing ethylenediamine and hydrochloric acid may be used as the coupling agent.

After the coupling operation, a catalyst bonding operation is performed by immersing the polyimide film in a mixed solution of palladium chloride (PaClₛ) and stannous chloride (SnCl₂) diluted with hydrochloric acid at a volume ratio of 1:1 for five minutes (S140). Palladium (Pa) and tin (Sn) in the mixed solution used in the coupling operation serve as catalysts and are attached to the coupling agent, thereby completing the catalyst bonding operation.

If the coupling operation is performed only for a short time, too little palladium and tin is attached onto the surface of the surface of the polyimide film, thereby making it less likely to fully obtain the benefits of the coupling operation. On the other hand, if the coupling operation is performed for a long time, the surface of the polyimide film may be corroded by hydrochloric acid included in the coupling agent.

After the catalyst bonding operation, a reaction acceleration operation is performed by immersing the polyimide film in a mixed solution of hydrated hydrazine acid and glycolic acid at room temperature for about three to five minutes (S150). As a result of the reaction acceleration operation, tin attached onto the surface of the polyimide film is removed, and thus, the surface of the polyimide film is activated enough to plate a metal film thereon. In this embodiment, tin, which is a carbon-group element, is removed from the surface of the polyimide film by the catalyst bonding operation.

If the reaction acceleration operation is performed for less than three minutes, tin attached onto the surface of the polyimide film may not be properly removed. Tin remained after the reaction acceleration operation serves as an impurity during a subsequent plating operation. On the other hand, if the reaction acceleration operation is performed for more than five minutes, not only tin ions but also palladium ions may be removed from the surface of the polyimide film by acid included in the mixed solution used in the reaction acceleration operation.

After the reaction acceleration operation, a first plating operation 5160 is performed so that the polyimide film can be plated with a first metal film (S160). In this embodiment, the first metal film is formed on the polyimide film using the electroless plating method.

The electroless plating method is a type of plating method that involves extracting metal ions in a plating solution through a chemical reaction of a reducing agent. Examples of the electroless plating method include a substitution plating method and a chemical reduction plating method.

In this embodiment, the chemical reduction plating method is used. However, the present invention is not restricted to this. In other words, the substitution plating method, instead of the chemical reduction plating method, may be used. The chemical reduction plating method involves plating a metal film by chemically extracting metal ions from a metal salt solution using a reducing agent. The first metal film may be formed to a desired thickness using the chemical reduction plating method, thereby enhancing the adhesiveness of the first metal film. The first metal film may be formed to a uniform thickness by uniformly immersing the polyimide film in an electroless plating solution.

An electroless plating solution containing an ethylenediamine tetraacetic (EDTA) acid (EDTA) aqueous solution, a caustic soda solution, a formalin aqueous solution, and a copper sulphate aqueous solution may be used in the first plating operation. The electroless plating solution may also contain a polish and a stabilizer which enable the reuse and long-term preservation of the electroless plating solution even after several times of use.

The first plating operation is performed on the polyimide film at a temperature of about 38-60° C. for several minutes using the electroless plating method so that the polyimide film can be plated with the first metal film. The thickness of the first metal film may be determined according to the duration for which the polyimide film is immersed in the electroless plating solution. If the first plating operation is performed at a temperature lower than 38° C., the electroless plating solution may not be properly activated, and thus, the polyimide film may not be able to be completely plated with the first metal film. On the other hand, if the first plating operation is performed at a temperature higher than 60° C., the uniformity and the adhesiveness of the first metal film may deteriorate.

The first plating operation may be performed for so such an amount of time that the entire surface of the polyimide film can be uniformly plated with the first metal film. The thickness of the first metal film may be less than or equal to 0.2 μm More specifically, the thickness of the first metal film may be about 0.1 μm.

If the first metal film is too thin, the performance of a second plating operation that involves the use of a current may deteriorate. If the thickness of the first metal film is greater than 0.2 fall, the time required to plate the polyimide film may increase, and thus, the peel strength of the first metal film may decrease due to minor components of the electroless plating solution. Therefore, the first metal film may be formed to a thickness of 0.2 μm or less, and particularly, a thickness of about 0.1 μm.

After the first plating operation, a drying operation is performed so that the first metal film can be dried out and stabilized (S170). More specifically, the first metal film may be stabilized by drying the polyimide film at a temperature of about 110-270° C. An inert gas such as argon (Ar) may be used in the drying operation so that the first metal film can be prevented from being oxidized by, for example, oxygen in the air.

If the drying operation is performed at a temperature lower than 110° C., the polyimide film may not be completely dried out, and thus, the adhesive strength and folding endurance of the polyimide film may not be able to be enhanced sufficiently. On the other hand, if the drying operation is performed at a temperature higher than 200° C., the polyimide film may be damaged. Therefore, the drying operation may be performed at a temperature of 110-200° C.

The drying operation may be performed for five to thirty minutes. If the drying operation is performed for less than five minutes, the polyimide film may not be completely dried out. On the other hand, if the drying operation is performed for more than thirty minutes, the polyimide film may be damaged.

After the drying operation, a second plating operation is performed (S180) for forming a second metal film on the first metal film. More specifically, a plating solution is prepared by diluting an aqueous solution of copper sulphate (CuSO₄—H₂O), sulfuric acid (H₂SO₄), and hydrochloric acid (HCl) with water. The plating solution may contain a small amount of polish and additive.

Thereafter, the polyimide film with the first metal film deposited or plated thereon is put in the plating solution, and a current is applied to the polyimide film at a temperature of about 20-35° C. for about thirty minutes, thereby forming a second metal film on the first metal film. During this process, the plating solution may be stirred, thereby preventing the concentration of the plating solution from becoming irregular. The conditions regarding the second plating operation may vary according to a desired thickness of the second metal film.

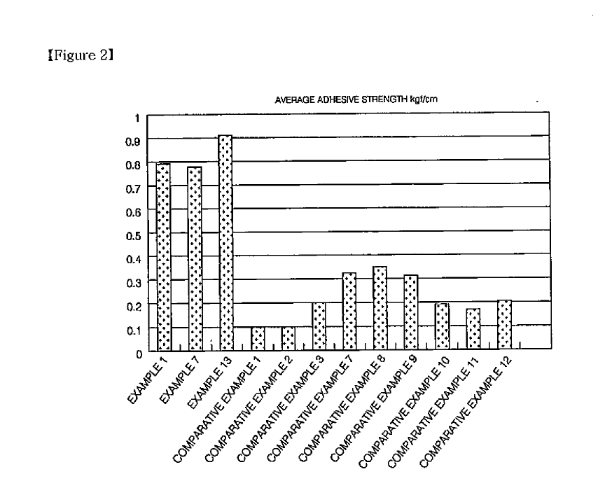

Flexible films obtained by performing operation S200 through S270 of FIG. 2 were tested for their physical properties (e.g., peel strength and folding endurance) according to the JIS-6471 standard, and the test results will be described later in detail with reference to FIGS. 2 and 3.

In this embodiment, a polyimide film may be formed of any type of polyimide that is suitable for use in the first and second plating operations (S160 and S180). For the above-mentioned tests, polyimide films having a width of 100 mm, a length of 190 mm, and a thickness of 38 μm were prepared, and a pretreatment operation for the fabrication of a flexible film was performed on the polyimide films by drying the polyimide films were dried at a temperature of 150° C. for about ten minutes in order to remove moisture. It is obvious to one of ordinary skill in the art to which the present invention pertains that the conditions regarding the fabrication of a flexible film according to the present invention may vary according to the type of a polyimide film and the conditions regarding the fabrication of the polyimide film.

### Example 1

A polyimide film was immersed in an aqueous solution containing an alkali or acid surfactant at room temperature for five minutes. Thereafter, the polyimide film was etched by immersing the polyimide film in a 5M sodium hydroxide solution at a temperature of 45° C. for about five minutes. The surface of the etched polyimide film was neutralized by immersing the etched polyimide film in 100 ml/l of HCl at room temperature for about five minutes.

Thereafter, a silane coupling agent containing an aminopropyltriethoxysilane was diluted at a ratio of 1.0%/l, and the neutralized polyimide film was immersed in the diluted silane coupling agent at a temperature of about 30° C. for five minutes. Thereafter, the polyimide film was dried at a temperature of about 100° C. for about five minutes, thereby stabilizing a coupling layer. Thereafter, the polyimide film was activated using a hydrochloric acid aqueous solution obtained by diluting 35% hydrochloric acid with distilled water at a volume ratio of 1:3, an alkali-based coupling agent containing sodium oxide and monomethylamine, or an acid-based coupling agent containing ethylenediamine and hydrochloric acid.

Thereafter, a catalyst bonding operation was performed on the polyimide film by immersing the polyimide film at room temperature for about five minutes in an aqueous solution obtained by diluting a mixed solution of 0.5 g of palladium chloride (PaClₛ), 2 g of stannous chloride (SnCl₂) and 1 L of distilled water with 3.5% hydrochloric acid at a volume ratio of 1:1.

Thereafter, tin was removed from the polyimide film by immersing the polyimide film in a mixed solution of 60 g of hydrated hydrazine acid (60%), 43 g of glycolic acid and 1 L of distilled water at room temperature for about five minutes.

Thereafter, a first metal film was formed on the polyimide film by immersing the polyimide film in an electroless plating solution at a temperature of about 45° C. for about one and a half minutes. The electroless plating solution was obtained by mixing a copper sulphate aqueous solution (15.8 g/L) with an aqueous solution of 4.2 g of EDTA, 13.7 g of caustic soda, 9.5 g of formalin and 1 L of distilled water. Thereafter, the polyimide film plated with the first metal film was dried in an argon gas atmosphere at a temperature of about 110° C. for about ten minutes.

Thereafter, the polyimide film was immersed at a temperature of about 25° C. for about thirty minutes in a plating solution obtained by diluting 130 g of copper sulphate (CuSO₄—H₂O), 110 g of sulfuric acid (H₂SO₄), and 10 ml of hydrochloric acid (HCl) with 1 L of ion exchanged water, and then a current of 2 A is applied to the polyimide film, thereby obtaining a flexible film having a double-layered structure and including a metal film with a thickness of about 8 μm.

### Example 2

Example 2 is the same as Example 1 except for using an aqueous solution of 5 g of pyrrolidone, 15 g of NMP and 125 of NaOH and 1 L of distilled water as an etching solution. As a result of Example 2, a flexible film having a double-layered structure was obtained.

### Example 3

Example 3 is the same as Example 1 except for using an acid coupling agent obtained by mixing 7 g of ethyleneamine and 7 g of 35% HCl with 1 L of ion exchanged water, instead of using a silane coupling agent. As a result of Example 3, a copper clad laminate (FCCL) film was obtained.

Flexible films obtained by Examples 1 through 3 were tested for their physical properties, and the test results are presented in Table 1 below. More specifically, the flexible films obtained by Examples 1 through 3 were examined with the naked eye for whether they are uniformly plated, and the adhesive strength (or peel strength) and folding endurance (R-0.38 mm, 500 g), of the flexible films obtained by Examples 1 through 3 were tested according to the JIS-6471 standard.

TABLE 1

| | Plating | Thickness of | Average Adhesive | Average Folding |
|---|---|---|---|---|
| | Uniformity | Metal Film (μm) | Strength (kg/cm) | Endurance (times) |
| Example 1 | ⊚ | 7.9 | 0.79 | 166 |
| Example 2 | ⊚ | 8.0 | 0.59 | 154 |
| Example 3 | ⊚ | 8.2 | 0.82 | 199 |

Referring to Table 1, reference character ⊚ indicates that a flexible film is very uniformly plated.

### Examples 4 Through 6

Examples 4 through 6 are the same as Examples 1 through 3, respectively, except for using nickel, instead of copper, as the material of a first metal film. As a result of each of Examples 4 through 6, a flexible film having a double-layered structure was obtained.

Examples 4 through 6 involve forming a first metal film of nickel by performing an electroless plating operation for at a temperature of about 45° C. for about two minutes using an electroless nickel plating solution which is obtained by dissolving 45 g of sodium hypophosphite, 12 g of sodium citrate, and 40 g of 6-number nickel sulfate in 1 L of ion exchanged water.

Flexible films obtained by Examples 4 through 6 were tested for their physical properties, and the test results are presented in Table 2 below.

TABLE 2

| | Plating | Thickness of | Average Adhesive | Average Folding |
|---|---|---|---|---|
| | Uniformity | Metal Film (μm) | Strength (kg/cm) | Endurance (times) |
| Example 4 | ⊚ | 7.9 | 0.68 | 129 |
| Example 5 | ⊚ | 7.9 | 0.79 | 147 |
| Example 6 | ⊚ | 8.0 | 0.71 | 169 |

Referring to Table 2, reference character ⊚ indicates that a flexible film is very uniformly plated.

### Examples 7 Through 12

Examples 7 through 12 are the same as Examples 1 through 6, respectively, except for drying a polyimide film plated with a first metal film at a temperature of 150° C. for twenty minutes. As a result of each of Examples 7 through 12, a flexible film having a double-layered structure was obtained.

Flexible films obtained by Examples 7 through 12 were tested for their physical properties, and the test results are presented in Table 3 below

TABLE 3

| | Plating | Thickness of | Average Adhesive | Average Folding |
|---|---|---|---|---|
| | Uniformity | Metal Film (μm) | Strength (kg/cm) | Endurance (times) |
| Example 7 | ⊚ | 7.9 | 0.78 | 147 |
| Example 8 | ⊚ | 7.8 | 0.86 | 146 |
| Example 9 | ⊚ | 8.1 | 0.72 | 148 |
| Example 10 | ⊚ | 8.0 | 0.76 | 149 |
| Example 11 | ⊚ | 8.0 | 0.81 | 155 |
| Example 12 | ⊚ | 8.1 | 0.82 | 159 |

Referring to Table 3, reference character ⊚ indicates that a flexible film is very uniformly plated.

### Examples 13 Through 18

Examples 13 through 18 are the same as Examples 1 through 6, respectively, except for drying a polyimide film plated with a first metal film at a temperature of 200° C. for about twenty minutes. As a result of each of Examples 13 through 18, a flexible film having a double-layered structure was obtained.

Flexible films obtained by Examples 13 through 18 were tested for their physical properties, and the test results are presented in Table 4 below

TABLE 4

| | Plating | Thickness of | Average Adhesive | Average Folding |
|---|---|---|---|---|
| | Uniformity | Metal Film (μm) | Strength (kg/cm) | Endurance (times) |
| Example 13 | ⊚ | 7.7 | 0.91 | 164 |
| Example 14 | ⊚ | 8.0 | 0.92 | 167 |
| Example 15 | ⊚ | 8.0 | 0.89 | 178 |
| Example 16 | ⊚ | 8.1 | 0.88 | 179 |
| Example 17 | ⊚ | 8.0 | 0.94 | 165 |
| Example 18 | ⊚ | 8.0 | 0.92 | 169 |

Referring to Table 4, reference character ⊚ indicates that a flexible film is very uniformly plated.

### Comparative Examples 1 Through 6

Comparative Examples 1 through 6 are the same as Examples 1 through 6, respectively, except for drying a polyimide film plated with a first metal film at room temperature for about thirty minutes. Flexible films obtained by Comparative Examples 1 through 6 were tested for their physical properties, and the test results are presented in Table 5 below.

TABLE 5

| | Plating | Thickness of | Average Adhesive | Average Folding |
|---|---|---|---|---|
| | Uniformity | Metal Film (μm) | Strength (kg/cm) | Endurance (times) |
| Comparative | ⊚ | 7.9 | 0.1 | 10 |
| Example 1 | | | | |
| Comparative | ⊚ | 8.1 | 0.1 | 10 |
| Example 2 | | | | |
| Comparative | ⊚ | 8.0 | 0.2 | 10 |
| Example 3 | | | | |
| Comparative | ⊚ | 7.9 | 0.64 | 131 |
| Example 4 | | | | |
| Comparative | ⊚ | 8.0 | 0.68 | 127 |
| Example 5 | | | | |
| Comparative | ⊚ | 8.0 | 0.61 | 126 |
| Example 6 | | | | |

Referring to Table 5, reference character ⊚ indicates that a flexible film is very uniformly plated. The average adhesive strength of flexible films obtained by Comparative Examples 1 through 3 is 0.1-0.2 kg/cm, as indicated in Table 5, and is much lower than the average adhesive strength (0.59-0.82 kg/cm) of flexible films obtained by Examples 1 through 3. The folding endurance of flexible films obtained by Comparative Examples 1 through 3 is 10, and is much less than the folding endurance (154-169) of flexible films obtained by Examples 1 through 3.

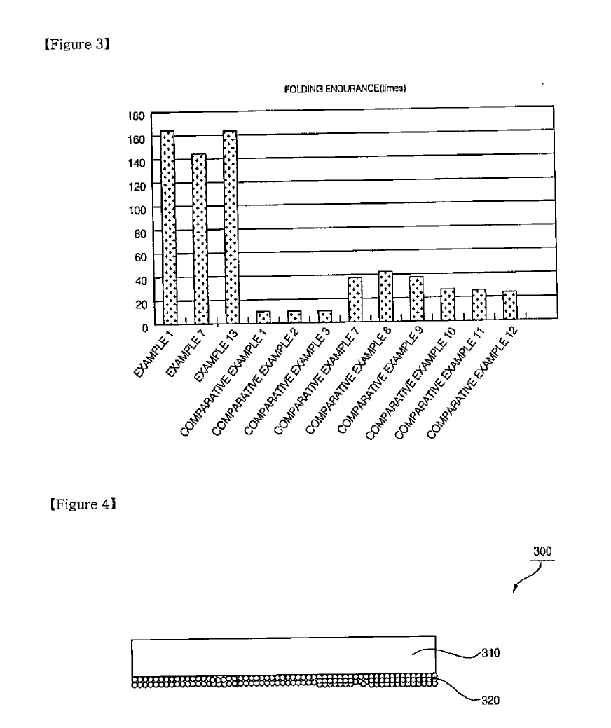

Comparative Examples 4 through 6 are the same as Comparative Examples 1 through 3, respectively, except for performing a nickel plating operation, instead of a copper plating operation. Referring to FIG. 4, the plating properties (i.e., average adhesive strength and folding endurance) of flexible films obtained by Comparative Examples 4 through 6 are generally poorer than the plating properties of flexible films obtained by Examples 1 through 3.

In other words, when a polyimide film plated with a first metal film is dried at room temperature as performed in Comparative Examples 1 through 6, the plating properties (i.e., average adhesive strength and folding endurance) of the first metal film may considerably deteriorate.

### Comparative Examples 7 Through 12

Comparative Examples 7 through 9 are the same as Examples 7 through 9, respectively, except for drying a polyimide film plated with a first metal film in an oxygen and nitrogen atmosphere with atmospheric pressure at a temperature of 150° C. for twenty minutes, instead of drying the polyimide film in an argon gas atmosphere at a temperature of 150° C. As a result of each of Comparative Examples 7 through 12, a conductive metal plated polyimide substrate was obtained.

Comparative Examples 10 through 12 are the same as Examples 13 through 15, respectively, except for drying a polyimide film plated with a first metal film in an oxygen and nitrogen atmosphere with atmospheric pressure at a temperature of 200° C. for twenty minutes, instead of drying the polyimide film in an argon gas atmosphere at a temperature of 200° C.

Conductive metal plated polyimide substrates obtained by Comparative Examples 7 through 12 were tested for their physical properties, and the test results are presented in Table 6 below.

TABLE 6

| | Plating | Thickness of | Average Adhesive | Average Folding |
|---|---|---|---|---|
| | Uniformity | Metal Film (μm) | Strength (kg/cm) | Endurance (times) |
| Comparative | ⊚ | 8.0 | 0.33 | 38 |
| Example 7 | | | | |
| Comparative | ⊚ | 8.1 | 0.35 | 42 |
| Example 8 | | | | |
| Comparative | ⊚ | 8.0 | 0.32 | 38 |
| Example 9 | | | | |
| Comparative | ⊚ | 8.0 | 0.19 | 29 |
| Example 10 | | | | |
| Comparative | ⊚ | 8.0 | 0.18 | 27 |
| Example 11 | | | | |
| Comparative | ⊚ | 8.0 | 0.21 | 26 |
| Example 12 | | | | |

Referring to Table 6, reference character ⊚ indicates that a flexible film is very uniformly plated. The test results presented in Table 6 imply that, when a polyimide film plated with a first metal film is dried in an oxygen and nitrogen atmosphere, instead of being dried in an argon gas atmosphere, the plating properties (i.e., average adhesive strength and folding endurance) of the first metal film may considerably deteriorate.

FIG. 2 illustrates a graph of average adhesive strength measurement results obtained from flexible films for use as chip-on-films (COFs), obtained by Examples 1, 7, 13 and Comparative Examples 1 through 12. Referring to FIG. 2, flexible films obtained by performing a drying operation in an oxygen and nitrogen atmosphere at room temperature as in the cases of Comparative Examples 1 through 3, performing a drying operation in an oxygen and nitrogen atmosphere at a temperature of 150° C. as in the cases of Comparative Examples 7 through 9, or performing a drying operation in an oxygen and nitrogen atmosphere at a temperature of 200° C. as in the cases of Comparative Examples 10 through 12 have generally weak adhesive strength. In other words, the adhesive strength of flexible films may not necessarily be increased simply by increasing the temperature of a drying operation.

Upon comparing Comparative Examples 1 through 3 with Comparative Examples 7 through 9, it is recognized that the adhesive strength of flexible films can be increased by increasing the temperature of a drying operation from 150° C. to 200° C. However, once the temperature of a drying operation exceeds 200° C., as in the cases of Comparative Examples 10 through 12, the adhesive strength of flexible films decreases, rather than increasing, in part because copper on the surface of first metal films reacts with oxygen in the air at high temperature and is thus oxidized.

On the contrary, Examples 1, 7 and 13 involve using an inert gas and increasing the temperature of a drying operation and can thus result in a considerable increase in the adhesive strength of flexible films.

FIG. 3 illustrates a graph of average folding endurance measurement results obtained from flexible films for use as chip-on-films (COFs), obtained by Examples 1, 7, 13 and Comparative Examples 1 through 12. Referring to FIG. 3, upon comparing Comparative Examples 1 through 3 in which a drying operation is performed in an oxygen and nitrogen atmosphere at room temperature, Comparative Examples 7 through 9 in which a drying operation is performed at a temperature of 150° C., Comparative Examples 10 through 12 in which a drying operation is performed at a temperature of 200° C., it is concluded that the folding endurance of flexible films is not necessarily increased simply by increasing the temperature of a drying operation.

More specifically, upon comparing Comparative Examples 1 through 3 with Comparative Examples 7 through 9, it is recognized that the folding endurance of flexible films is increased by increasing the temperature of a drying operation from room temperature to 150° C. On the other hand, upon comparing Comparative Examples 7 through 9 with Comparative Examples 10 through 12, it is recognized that the folding endurance of flexible films is not increased but reduced by increasing the temperature of a drying operation from 150° C. to 200° C. in part because copper on the surface of first metal films reacts with oxygen in the air at high temperature and is thus oxidized.

On the contrary, Examples 1, 7 and 13 involve using an inert gas and increasing the temperature of a drying operation and can thus result in a considerable increase in the folding endurance of flexible films.

FIG. 4 illustrates a cross-sectional view of a flexible film 300 according to an embodiment of the present invention, FIG. 5 illustrates a cross-sectional view of a flexible film 400 according to another embodiment of the present invention, and FIG. 6 illustrates a cross-sectional view of a flexible film 500 according to another embodiment of the present invention. Referring to FIG. 4, the flexible film 300 includes a polyimide film 310 which is insulated and a metal film 320 which is plated on the polyimide film 310.

An imide ring on the surface of the polyimide film 310 may be opened by performing an etching operation, before the formation of the metal film 320, using at least one of potassium hydroxide (KOH), a mixed solution of ethylene glycol and KOH, sodium hydroxide (NaOH), a mixed aqueous solution of pyrrolidone and NaOH, and a mixed solution of chromic anhydride and sulfuric acid. Also, the surface of the polyimide film may be polarized by applying a coupling agent to the opened imide ring of the polyimide film 310. In this manner, it is possible to increase the peel strength of the metal film 320. The coupling agent may include a silane radical or an amine radical.

The metal film 320 may include copper (Cu). The polyimide film 310 may have a thickness of 10-40 μm, and the metal film 320 may have a thickness of 0.5-35 μm.

Referring to FIG. 5, the flexible film 400 is a double-layered, double-sided flexible film. The flexible film 400 includes a polyimide film 410, a first metal film 420a which is deposited or plated on the polyimide film 410, and a second metal film 420b which is deposited or plated on the first metal film 420a.

The flexible film 400 also includes an adhesive layer which is formed on the second metal film 420b, a protective layer which is formed on the adhesive layer 430, and a kapton tape which is formed on part of the protective layer.

Referring to FIG. 6, the flexible film 500 is a double-layered, single-sided flexible film. The flexible film 500 includes a polyimide film 510, a first metal film 520a which is deposited or plated on the polyimide film 510, and a second metal film 520b which is deposited or plated on the first metal film 520a. The flexible film 500 may also include an adhesive layer and a protective layer which are sequentially formed on the second metal film 520b.

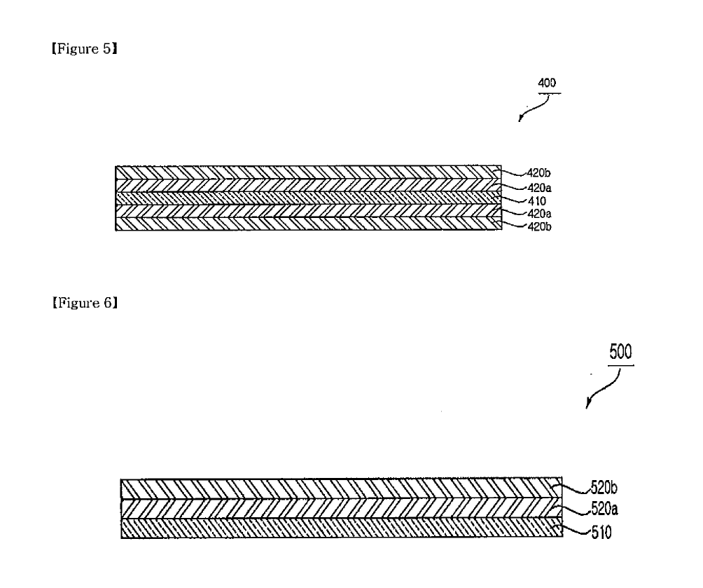

Referring to FIGS. 6 and 7, the first metal film 420a or 520a may be formed of at least one of Au, Ni, and Cu. The second metal film 420b or 520b may be formed of at least one of Au and Cu. Alternatively, the first metal film 420a or 520a and the second metal film 420b or 520b may both be formed of Cu, thereby reducing the manufacturing cost.

The adhesive strength of the first metal film 420a or 520a may be enhanced by applying a catalyst to the polyimide film 410 or 510. For this, the polyimide film 410 or 510 may be immersed in a mixed solution of palladium chloride (PaClₛ) and stannous chloride (SnCl₂) diluted with hydrochloric acid at a volume ratio of 1:1. The adhesive strength of the polyimide film 410 or 510 may be further enhanced by removing tin (Sn) from the surface of the polyimide film 410 or 510 and leaving only palladium (Pa) ions on the surface of the polyimide film 410 or 510.

After the formation of the first metal film 420a or 520a on the polyimide film 410 or 510, the polyimide film 410 or 510 may be dried in an atmosphere of an inert gas at a temperature of 110-200° C. for five to thirty minutes, thereby enhancing the adhesive strength and folding endurance of the polyimide film 410 or 510 and stabilizing the first metal film 420a or 520a. The inert gas may be an argon gas.

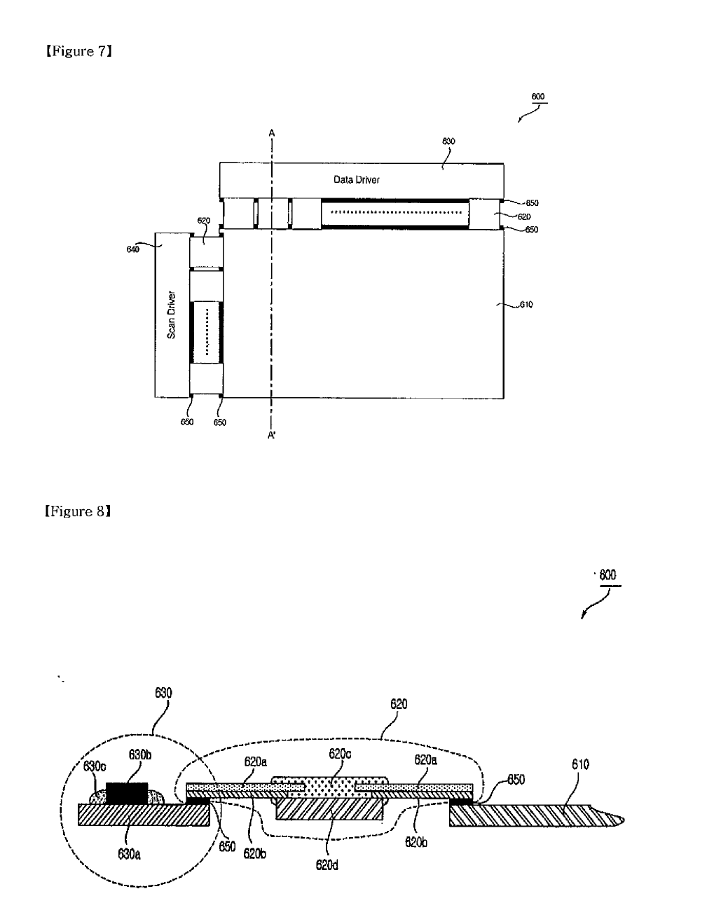

FIGS. 7 and 8 illustrate a display device 600 having flexible films, according to an embodiment of the present invention. In this embodiment, the display device 600 is a flat panel display device such as a liquid crystal display (LCD) device, a plasma display panel (PDP) device or an organic light emitting diode (OLED) display device.

Referring to FIG. 7, the display device 600 includes a panel 610 which displays an image, tape carrier packages (TCPs) 620 which connect the panel 610 and a driver integrated circuit (IC), and a driving unit which applies a driving signal to the panel 610. The display device 600 also includes a plurality of anisotropic conductive films (ACF) 650 which electrically connect the driving unit and the TCPs 620 and/or electrically connect the TCPs 620 and the panel 310. The driving unit may include a data driver 630 and a scan driver 640.

The panel 610 includes a plurality of devices for displaying an image. If the display device 600 is driven in an active matrix manner, the panel 610 may include a transistor and a capacitor necessary for driving each pixel. When the scan driver 640 selects a scan electrode and the data driver 630 applies a voltage to a data electrode to which the selected scan electrode is connected, an image is displayed on the panel 610.

Each of the TCPs 620 may be a circuit board which includes a flexible film and a circuit pattern printed on the flexible film and on which a driving IC is disposed. The TCPs 620 transmit a driving signal transmitted by the driving unit to the panel 610. The panel 610 and the data driver 630 may be connected by a TCP, and the panel 610 and the scan driver 640 may be connected by a COF. Alternatively, the panel 610 and the data driver 630 may be connected by a COF, and the panel 610 and the scan driver 640 may also be connected by a COF.

FIG. 8 illustrates a cross-sectional view taken along line A-A of FIG. 7. Referring to FIG. 8, the panel 610 is electrically connected to a TCP 620 by an ACE 650. The ACF 650 includes a number of conductive balls and can thus electrically connect the panel 610 and the TCP 620.

The TCP 620 includes a polyimide film 620a, a metal film 620b formed on the polyimide film 620a, a resin protective layer 620c and an IC chip 620d. The IC chip 620d transmits a signal transmitted by the driving unit of FIG. 7 to the panel 610 and is encapsulated by the resin protective layer 620c.

The TCP 620 is electrically connected to the driving unit by the ACF 650. More specifically, referring to FIG. 8, the flexible film 620 is connected to the data driver 630 by the ACF 650.

The data driver 630 includes a printed circuit board (PCB) 630a and a circuit device 630b and dielectric materials 630c which are all formed on the PCB 630a. The PCB 630a may be a flexible film including a polyimide film with a circuit pattern printed thereon and a metal film deposited or plated on the polyimide film.

When a data input command is received, the circuit device 630b transmits an electric signal corresponding to the data input command to the PCB 630a. The electric signal is transmitted through the circuit pattern on the PCB 630a. Then, the electric signal is transmitted to the metal film 620b of the flexible film 620 through the ACF 650, and the IC chip 620d of the flexible film 620 applies the electric signal to the panel 610, thereby displaying an image on the panel 610.

### INDUSTRIAL APPLICABILITY

According to the present invention, it is possible to fabricate a flexible film without a requirement of an adhesive layer and thus provide a flexible film with excellent physical properties such as excellent plating properties, high adhesive strength, high heat resistance, high drug resistance, excellent migration properties and high folding endurance. In addition, according to present invention, it is easy to realize micro circuits. Thus, the present invention can be applied to the manufacture of various products such as COFs, radio frequency identification (RFID) antennas or electromagnetic wave shield films for PDP devices.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of fabricating a flexible film, the method comprising:
opening an imide ring on a polyimide film;
applying a catalyst to the polyimide film;
removing tin from the catalyst;
forming a first metal film on the polyimide film;
drying the polyimide film having the first metal film at a temperature of 110-200° C.; and
forming a second metal film on the first metal film.

2. The method of claim 1, wherein the opening the imide ring, comprises immersing the polyimide film in at least one of potassium hydroxide (KOH), a mixed solution of ethylene glycol and KOH, sodium hydroxide (NaOH), a mixed aqueous solution of pyrrolidone and NaOH, and a mixed solution of chromic anhydride and sulfuric acid.

3. The method of claim 1, wherein the forming the first metal film, comprises disposing at least one of gold, nickel, and copper.

4. The method of claim 1, wherein the forming the second metal film, comprises disposing at least one of gold, and copper.

5. The method of claim 1, wherein the drying the polyimide film, comprises drying the polyimide film at a temperature of 110-200° C. for five to thirty minutes in an atmosphere of an inert gas.

6. The method of claim 5, wherein the inert gas is an argon (Ar) gas.

7. The method of claim 1, wherein the catalyst comprises at least one of palladium and tin.

8. The method of claim 1, wherein the applying the catalyst, comprises immersing the polyimide film in a mixed solution of palladium chloride and tin chloride.

9. The method of claim 1, wherein the applying the catalyst, comprises immersing the polyimide film in a mixed solution of palladium chloride and tin chloride for 3 to 10 minutes.

10. The method of claim 1, further comprising applying ultrasonic waves to the polyimide film so as to induce successive reactions.

11. The method of claim 1, further comprising applying a coupling agent to the opened imide ring of the polyimide film.

12. The method of claim 9, wherein the coupling agent comprises at least one of a silane radical and an amine radical.

13. The method of claim 9, wherein the applying the coupling agent, comprises immersing the polyimide film in at least one of a silane coupling agent containing an aminopropyltriethoxysilane, an alkali-based coupling agent containing sodium oxide and monomethylamine, and an acid-based coupling agent containing ethylenediamine and hydrochloric acid.

14. The method of claim 1, further comprising immersing the polyimide film having the opened imide ring in an acid solution.
